(19) United States
(12) Patent Application Publication
(10) Pub. No.: US 2004/0140668 A1
(43) Pub. Date: Jul. 22, 2004

(54) Pipe connection

(75) Inventors: Sylvia Monsheimer, Haltern am See (DE); Rainer Goering, Borken (DE); Hans Ries, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/670,528

(22) Filed: Sep. 26, 2003

(30) Foreign Application Priority Data
Sep. 27, 2002 (DE) 102 45 355.1

(51) Int. Cl. F16L 33/00

(52) U.S. Cl. 285/256; 285/288.1

(57) ABSTRACT

A method for connecting a plastic pipe to another plastic part, wherein an outer layer of the plastic pipe and an outer layer of the other plastic part are largely opaque to laser light, in which both the plastic pipe and the other plastic part are sheathed at the ends by an adaptor made of a plastic transmissive to laser light, and the adaptor is fastened by means of laser welding. In other embodiments, an adaptor of a material transmissive to laser light is molded together with another plastic part by a two-component injection-molding process, or the adaptor is molded and then overmolded to the other plastic part. This is followed by insertion of the pipe into the adaptor and fastening of the pipe to the adaptor by laser welding. The invention also relates to the composite parts produced according to this method.

### BACKGROUND OF THE INVENTION

Field of the Invention

The present invention relates to a novel method for connecting a single-layered or multi-layered pipeline to another plastic part, such as for example a quick connector.

Connections between a pipe and a plastic part in which the pipe is flared onto the plastic part are known. This involves expanding the pipe in order to receive the nipple of the plastic part. After that, the pipe bears the impression of the profile of the nipple, if there is one. This connection has to meet the requirements that it is as impermeable and leaktight as possible, can withstand high pulling-out forces and is torsionally secure. Especially in the case of the connection of a fuel line and a quick connector, the use of “wedding bands” is also known. The “wedding band” is pushed onto the pipe before flaring and is likewise made to expand during the flaring, so that the additional material increases the forces required for pulling the connector out.

In particular at high temperatures, as often occur in the engine compartment of a motor vehicle, there is a deterioration in the capabilities of the flared connection. The pulling-out resistance and the torsional security diminish acutely, so that under some circumstances the integrity of the connection is no longer ensured. In other applications too, for example in medical engineering, the integrity and rigidity of the connection must be ensured.

One possible way of overcoming this problem is to weld the two components that are to be connected, for example by high-speed hot-gas welding, infrared welding, electric socket welding or by means of a high-frequency field. In general, one of the disadvantages of these methods is that complex fixing of the parts to be connected is necessary in order to avoid distortion in the cooling phase. In addition, on account of high volumes of melt, relatively great cycle times are required for heating up, connecting and cooling down. In particular in the case of small wall thicknesses, it is very difficult to achieve a secure weld by these conventional welding techniques.

In DE-A-199 16 786, a description is given of a method of connecting at least two tube and/or wall elements consisting of plastic in which the action of a laser is used to weld a laser-transmissive plastic to a plastic absorbing laser beams. However, this method cannot be applied to the welding of, for example, a fuel line to a quick connector. The fuel line is generally not laser-transmissive, since it is usually made up of a number of layers and includes, for example, an outer layer pigmented with carbon black, a barrier layer or an inner layer made electrically conductive by carbon black. Consequently, the quick connector would have to consist of a laser-transmissive material. However, the introduction of laser optics into the inner channel of a quick connector is out of the question with typical inside diameters of, for example, 8 mm, so that the pipe would have to be pushed into the nipple in order for the laser beam to be able to penetrate through the transmissive material from the outside as far as the welding point. In this case, however, it cannot be ensured that the pipe will remain dimensionally stable. If it buckles in, a leakfree connection is no longer possible. In any case, quick connectors are usually not laser-transmissive.

### SUMMARY OF THE INVENTION

Accordingly, the object of the invention is to connect a pipe firmly to another plastic part by laser welding, even if both parts to be connected are not transmissive to laser light. The inventors have discovered a method for connecting a plastic pipe to another plastic part in which the outer layer of the plastic pipe and the outer layer of the other plastic part are largely opaque to laser light of a certain wavelength and both the plastic pipe and the other plastic part are sheathed at the ends by an additional adaptor made of a plastic transmissive to laser light, which is subsequently fastened by means of laser-beam welding. As further explained below, the following two general embodiments are comprised here:

a) the adaptor is a sleeve which is fitted at the connecting point over the ends of the plastic pipe and of the other plastic part and is subsequently fastened to both by laser welding,

b) the adaptor likewise has the form of a sleeve, but is already connected beforehand to the other plastic part, for example by overmolding or molding on; subsequently, it is fitted over the end of the plastic pipe and then fastened there by laser welding.

The plastic pipe usually serves for carrying fuels, solvents, oils, gases, crop protection agents or the like. In a preferred embodiment it is a gas transport line or a motor-vehicle pipeline, in particular a fuel line, a coolant line, a brake fluid line, a hydraulic fluid line or a line of a windshield washing system. The pipe may be single-layered or multi-layered; up to seven layers are technically feasible at present, the multi-layered construction being justified by the necessity for a barrier layer which hinders the permeation of fuel components. While the functional layers generally consist of a molding composition based on polyamide or polyolefin, the barrier layer consists of a molding composition based on, for example, polyester, fluoropolymers or ethylene-vinyl alcohol copolymers. An antistatic inner layer, if present, consists of a molding composition which is made antistatic by adding an electrically conductive component such as for instance conductive carbon black or graphite fibrils. Corresponding pipes are state of the art and are described in many publications. They may be produced by conventional extrusion or coextruded by means of a tube or disk calibration or by means of shaping jaws (corrugated pipe take-off). Blow molding, for example suction blow molding or blow molding by means of parison manipulation, are also known as production processes for corresponding single-layer or multi-layer pipes.

The other plastic part, to be connected to the pipe, may be, for example, a quick connector, a branch, a valve, a cover for the pipe, or another pipe. The part has at least one nipple, which is provided for the connection to the pipe. This nipple may be of a smooth form, but it may also be provided on the outside with a profile, such as for example a fir-tree profile or an olive profile in the case of quick connectors. The combination of a sharp-edged profile with a smooth profile, for example an olive profile and a fir-tree profile, has proven to be particularly advantageous for the connection produced by means of laser welding. The plastic part usually consists of a single material, but may also consist of a number of different materials and is then produced for example by multi-component injection molding. The material may also be reinforced, for instance by means of glass or carbon fibers, or it may be made antistatic, for which carbon fibers likewise come into consideration, or else conductive carbon black, graphite fibrils or any other suitable additive.

In a further embodiment, the composite part is a component of a medical device, whereby a pipe is connected, for example, with a blood pouch, a valve, a connecting member, or a branch.

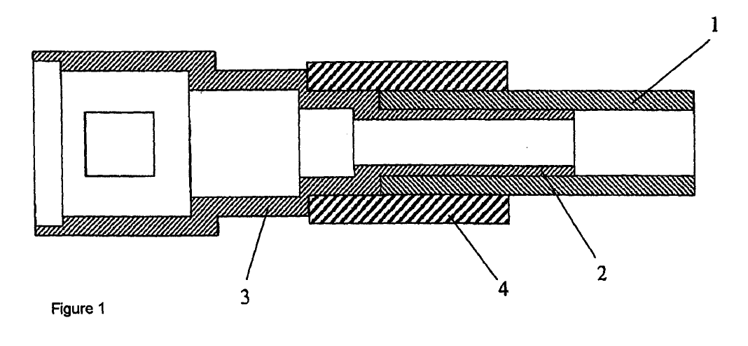

The additional adaptor, made of a plastic transmissive to laser light, sheathes the point to be connected in the manner of a sleeve. In a first preferred embodiment, the “wedding band” known from the prior art is used for this. This is a sleeve of thermoplastic material, that is a portion of pipe which covers the connecting point. A corresponding device is described in U.S. Pat. No. 5,090,745A (which is herein incorporated by reference in its entirety); it is referred to there as a “pressure sleeve”; the connection is achieved there by pressing in the connector body, that is for example the quick connector. This is intended in the prior art to increase the pulling-out forces and the rigidity with respect to laterally acting loading and also to improve the torsional security. The preferred embodiment according to the invention is explained by way of example in FIG. 1. The pipe 1 has been fitted on the nipple 2 of a quick connector 3; a part of the pipe 1 and, as a difference from U.S. Pat. No. 5,090,745A, of the quick connector 3 is sheathed by a “wedding band” 4. The latter is connected both to the quick connector 3 and to the pipe 1 by two peripheral welds (not shown in FIG. 1).

In a second preferred embodiment, the adaptor of a material transmissive to laser light is molded together with the other plastic part directly by the two-component injection-molding process, so that only one weld with respect to the pipe is then required.

In a third preferred embodiment, the adaptor is produced by means of a customary processing method, for example injection molding or extrusion, then placed into the mold for the other plastic part and subsequently molded on or overmolded. In this case, likewise only one weld with respect to the pipe is then required.

In a fourth preferred embodiment, the other plastic part is produced by means of a customary processing method, for example imjection molding or extrusion, then placed into the mold for the adaptor and subsequently molded on or overmolded. In this case, likewise only one weld with respect to the pipe is then required.

As in the case of the commonly used way of connecting a quick connector by flaring, the pipe can be pushed over the nipple on the plastic part; in principle, however, it is sufficient if the pipe and the plastic part just butt together, dispensing with the flaring process. Tests have shown that the integrity and load-bearing capacity of such a connection is equally good, and under thermal loading even better, than the conventional solution.

The adaptor consists of a thermoplastic material which is compatible both with the material of the outer surface of the plastic pipe and with the material of the outer surface of the other plastic part in such a way that an adequately firm welded connection can be achieved. Appropriate material combinations are known to a person skilled in the art. In the simplest case, both outer surfaces consist of a polyamide 12 (PA12) molding composition; in this case, the adaptor will advantageously consist of a molding composition based on PA12 homopolymers or copolymers, PA1012 or PA1212, which are known to be compatible with PA12. Embodiments in which the adaptor is of a multi-layered form are also possible, a comparatively thick outer layer ensuring strength and transmissiveness to laser light and a comparatively thin inner layer, which then does not need to be as transmissive to laser light, being optimized with regard to material compatibility. In this way it is possible, for example, to connect a pipe having an outer surface of a PA12 molding composition and another plastic part having an outer surface of a polybutylene terephthalate (PBT) molding composition with an adaptor which has a thick outer layer of PA12 and a thin inner layer of a PA12/PBT blend which has been made compatible, it being possible for it to be made compatible in a way corresponding to the prior art, for example by a PA12/PBT block copolymer or by a polyethylene imine/polyamide graft copolymer. The inner layer of the adaptor can be firmly welded to the two outer layers.

A plastic is transmissive to laser light if it is transparent or translucent in the wavelength range of the laser used. It is generally the case that pure polymers or their mixtures are adequately transparent or translucent, i.e. they absorb only poorly, in the given layer thicknesses (preferably a maximum of 5 mm). If it is required for design reasons, the molding composition of the adaptor may, as known from DE 199 60 104 A1 (which is herein incorporated by reference in its entirety), be pigmented by means of a combination of at least two coloring agents in such a way that a dark color impression results, it being necessary for the molding composition to be largely transparent or translucent in the IR range at the wavelength of the laser used.

The outer layer of the plastic pipe and the outer layer of the other plastic part are adjusted to be opaque to laser light, in that additives in particle form which absorb the laser light in the wavelength range of the laser used, for example carbon black, calcium silicate or iron oxide, are added to the respective molding compositions. Instead of pigments of this type, organic dyes or UV absorbers may also be added.

For the application of the laser welding method, conventional solid-state lasers, gas lasers or semiconductor lasers are suitable. The wavelength of the laser beam preferably lies in the range between 400 and 2000 nm. During welding, a continuous circumferential weld is preferably created. If increased requirements are demanded in respect of the strength and integrity, two or more welds may also be created directly next to each other.

The method according to the invention produces connecting points which have improved pulling-out resistance and torsional security even at relatively high temperatures. The composite parts produced in this way are likewise considered to be covered by the invention.

This application claims benefit of priority under 35 U.S.C. § 119 to DE 102 45 355.1, which is herein incorporated by reference in its entirety.

We claim:

1. A method for connecting a plastic pipe to another plastic part, wherein an outer layer of the plastic pipe and an outer layer of the other plastic part are largely opaque to laser light of a certain wavelength, comprising the steps of:
a) sheathing both the plastic pipe and the other plastic part ends thereof by an additional adaptor made of a plastic transmissive to laser light, and
b) fastening the adaptor to at least one of the plastic pipe and the other plastic part by laser-beam welding.

2. The method of claim 1, wherein the plastic pipe is a multi-layer pipe comprising a barrier layer.

3. The method of claim 1, wherein the plastic pipe is a multi-layer pipe comprising an antistatic inner layer.

4. The method of claim 1, wherein the plastic pipe is a multi-layer pipe comprising a barrier layer and an antistatic inner layer.

5. The method of claim 1, wherein the other plastic part is a pipe.

6. The method of claim 1, wherein the other plastic part is selected from the group consisting of a quick connector, a branch, a valve and a cover for the pipe.

7. The method of claim 1, wherein the adaptor is a sleeve.

8. The method of claim 1, further comprising welding the adaptor onto the pipe and onto the other plastic part by at least one peripheral weld in each case.

9. A composite part produced by the method of claim 1.

10. The composite part of claim 9, wherein the composite part is a motor-vehicle pipeline.

11. The composite part of claim 9, wherein the composite part is a gas transport line.

12. The composite part of claim 9, wherein the composite part is a component of a medical device.

13. The composite part of claim 10, wherein the composite part is a pipeline selected from the group consisting of a fuel line, a coolant line, a brake fluid line, a hydraulic fluid line, and a line of a windshield washing system.

14. A method for connecting a plastic pipe to another plastic part, wherein an outer layer of the plastic pipe and an outer layer of the other plastic part are largely opaque to laser light of a certain wavelength, comprising the steps of:
(a) molding an additional adaptor of a material transmissive to laser light together with the other plastic part by a two-component injection-molding process,
(b) inserting the pipe into the adaptor, and
(c) fastening the pipe to the adaptor by means of at least one weld.

15. The method of claim 14, wherein the at least one weld is a laser weld.

16. A composite part produced by the method of claim 14.

17. The composite part of claim 16, wherein the composite part is a motor-vehicle pipeline.

18. The composite part of claim 16, wherein the composite part is a gas transport line.

19. The composite part of claim 16, wherein the composite part is a component of a medical device.

20. The composite part of claim 17, wherein the composite part is a pipeline selected from the group consisting of a fuel line, a coolant line, a brake fluid line, a hydraulic fluid line, and a line of a windshield washing system.

21. A method for connecting a plastic pipe to another plastic part, wherein an outer layer of the plastic pipe and an outer layer of the other plastic part are largely opaque to laser light of a certain wavelength, comprising the steps of:
(a) molding an additional adaptor of a plastic transmissive to laser light onto the other plastic part,
(b) inserting the pipe into the adaptor, and
(c) fastening the pipe to the adaptor by means of at least one weld.

22. The method of claim 21, wherein the at least one weld is a laser weld.

23. A composite part produced by the method of claim 21.

24. The composite part of claim 23, wherein the composite part is a motor-vehicle pipeline.

25. The composite part of claim 23, wherein the composite part is a gas transport line.

26. The composite part of claim 23, wherein the composite part is a component of a medical device.

27. The composite part of claim 24, wherein the composite part is a pipeline selected from the group consisting of a fuel line, a coolant line, a brake fluid line, a hydraulic fluid line, and a line of a windshield washing system.

28. A method for connecting a plastic pipe to another plastic part, wherein an outer layer of the plastic pipe and an outer layer of the other plastic part are largely opaque to laser light of a certain wavelength, comprising the steps of:
(a) molding the other plastic part onto an adaptor of a plastic transmissive to laser light,
(b) inserting the pipe into the adaptor, and
(c) fastening the pipe to the adaptor by means of at least one weld.

29. The method of claim 28 wherein the at least one weld is a laser weld.

30. A composite part produced by the method of claim 28.

31. The composite part of claim 30, wherein the composite part is a motor-vehicle pipeline.

32. The composite part of claim 30, wherein the composite part is a gas transport line.

33. The composite part of claim 30, wherein the composite part is a component of a medical device.

34. The composite part of claim 31, wherein the composite part is a pipeline selected from the group consisting of a fuel line, a coolant line, a brake fluid line, a hydraulic fluid line, and a line of a windshield washing system.
